(19) United States
(12) Patent Application Publication
(10) Pub. No.: US 2013/0094444 A1
(43) Pub. Date: Apr. 18, 2013

(54) AUTOMATIC PROVISIONING OF AN M2M DEVICE HAVING A WIFI INTERFACE

(71) Applicant: Applied Communications Sciences, Piscataway, NJ (US)

(72) Inventors: Ming-Yee Lai, Short Hills, NJ (US); Dana Chee, Maplewood, NJ (US); Christian Makaya, New Brunswick, NJ (US); Fuchun Joseph Lin, Morris Plains, NJ (US); Kenji Hori, Kawagoe-shi (JP); Kiyohito Yoshihara, Wako-shi (JP)

(73) Assignee: Applied Communications Sciences, Piscataway, NJ (US)

(21) Appl. No.: 13/650,701

(22) Filed: Oct. 12, 2012

Related U.S. Application Data
(60) Provisional application No. 61/546,680, filed on Oct. 13, 2011.

(51) Int. Cl. H04W 60/00

(52) U.S. Cl. 370/328

(57) ABSTRACT

A method for automatically provisioning a WiFi-equipped machine-to-machine (M2M) device is disclosed. A WiFi M2M gateway identifies a WiFi network identifier broadcast by a powered-on M2M device in WiFi ad hoc mode through a scanning procedure and joins the ad hoc network defined by the M2M device. The WiFi M2M gateway obtains device information (e.g., MAC address) of the M2M device. The WiFi M2M gateway transmits a command to the M2M device to switch from ad hoc mode to infrastructure mode. The WiFi M2M gateway registers the M2M device with an M2M server associated with a service provider based on the device information of the M2M device. The WiFi M2M gateway receives a fully qualified domain name (FQDN) associated with the M2M device from the M2M server.

### CROSS-REFERENCE TO RELATED APPLICATIONS

This application claims the benefit of U.S. provisional patent application No. 61/546,680 filed Oct. 13, 2011, the disclosure of which is incorporated herein by reference in its entirety.

### FIELD OF THE INVENTION

The present invention relates to automatic provisioning of machine-to-machine (M2M) devices. More particularly, the present invention relates to a system and method for automating the provisioning of M2M devices with a WiFi interface over a wide area wired or wireless network.

### BACKGROUND OF THE INVENTION

In recent years, numerous in-home appliances have been provided with computer processor base control. As a result of the introduction of the World Wide Web in the mid-1990's, many devices have become programmable either locally via a built-in user interface (e.g., a microwave oven), locally via a an external user interface provided by a personal computer with a cable connection (e.g., USB), or remotely via a telephone network or a cable network employing an Internet and/or a local area network. One class of remotely-programmable appliances/devices is known as a machine-to-machine (M2M) device. As used herein, an M2M device has at least one communication interface to interact with other devices or servers, but has no or a limited human interface. In the future, devices employing M2M communications may become a dominant form of traffic and service supported by communications networks, including the Internet. M2M devices may include, for example, smart meters, cleaning robots, smart appliances, home security systems, e-health monitors, and telematic on-board-units. As defined herein, M2M devices do not include smart phones, tablets, or laptop/desktop computers.

Conventional remotely-programmable M2M devices have employed a number of communications media, interfaces, and protocols. M2M communications media, interfaces, and protocols may include, for example, a wide area network (WAN), a local area network (LAN), or combinations of both. A WAN may be, for example, a wireless WAN (WWAN) or a fixed (wireline) WAN (FWAN). Similarly, a LAN may be, for example, a wireless LAN (WLAN) or a fixed LAN (FLAN). Table 1 shows a non-exhaustive list of network, media, and protocol flavors of WWAN, FWAN, WLAN, FLAN networks currently available for communication with and between M2M devices.

TABLE 1

| Network | |
|---|---|
| Type | Network Examples |
| WWAN | GPRS, EDGE, WCDMA, EVDO, HSPA, LTE, WiMAX |
| FWAN | Power Line Communication, Fiber, Cable, DSL |
| WLAN | WiFi, Bluetooth, Zigbee, Dedicated Short Range Communication |
| FLAN | Ethernet, RS232, TIA485, Controller Access Network |

Before an M2M device may be connected to, addressable by, and managed by a network, the M2M device needs to be provisioned. Conventionally, M2M devices have been manually provisioned for later remote access by users. Moreover, in order for conventional M2M devices to be managed remotely by a service provider, additional manual provisioning is needed to assign a FQDN (Fully Qualified Domain Name) to an M2M device so that it may be addressable over a network by a service provider or a user.

Still further, although mobile devices (e.g., handsets, tablets) connected to a WWAN (e.g., 2G, 3G, 4G cellular network) and fixed modems connected to a FWAN (e.g., cable, DSL, fiber) can be provisioned using automatic provisioning schemes for some years, the current automatic provisioning schemes for mobile devices and fixed modems cannot be applied to M2M devices having only a WiFi interface that requires a gateway to communicate with a WAN. To enable automatic provisioning of such M2M devices with no or a minimal human interface, the WiFi interface in the M2M device needs to be initially set to ad hoc mode, instead of infrastructure mode, which may require WiFi network selection by a human being (as in handsets, tablets, or laptops).

FIG. 1 illustrates a conventional hardware architecture 100 for manually provisioning a WiFi-equipped M2M device 102 over the Internet 112. The WiFi-equipped M2M device 102 (M2M Device A) is located within a coverage area (i.e., the gateway area 104) serviced by a Customer Premise Equipment (CPE) gateway 106. The M2M device 102 may be provided with access to a WAN connecting with the Internet 112 via a wireless router (i.e., a WiFi access point) and a WAN gateway (e.g., a cable/DSL/fiber/WiMAX modem, a router, or a 3G/4G radio device) or a CPE gateway (e.g., a 3G/4G MiFi, or combined box with Fiber modem and wireless router), the latter combining the functions of a wireless router and a WAN gateway. As used herein, a CPE gateway (e.g., a CPE Gateway A 106) denotes a node that connects to the M2M device 102 with the WAN 112. The CPE gateway 106 additionally provides a network address translation (NAT) function for M2M devices that are accessed with a private IPv4 address.

In operation, the M2M device 102 in a gateway area 104 is provisioned manually by a user 108 through a local host 110 (e.g., a computer) to provide the M2M device 102 with network connectivity (e.g., by assigning one or more IP addresses to the M2M device 102 and by permitting port forwarding of data from the M2M device 102, etc.) so that the M2M device 102 becomes accessible to a remote controlling host 122 (e.g., a smart phone or a laptop) or to another M2M device 118 within another gateway area covered by a second CPE gateway 116 (e.g., M2M Device B 118) with a private address, or to another M2M device 120 (e.g., M2M Device C 120) having a public IP address. A public dynamic DNS sever 114 permits the M2M device 102 to be provided with remote Internet access behind the CPE gateway 106.

FIG. 2 is a process flow diagram 200 illustrating a conventional manual method for provisioning an IP M2M device 102 with a WiFi interface. The user 108 is physically located behind the CPE gateway 106. At block 205, the user 108 connects the M2M device 102 to the CPE gateway 106 with a WiFi interface using a local host 110 physically within the gateway area 104 covered by the CPE gateway 106. At block 210, the user 108 registers the M2M device 102 using a dynamic DNS server 114 to permit remote Internet access to the M2M device 102 behind the CPE gateway 106. At block 215, the user 108 sets the M2M device 102 to WiFi infrastructure mode and assigns an IP address (private or public) and an external IP port to the M2M device 102. At block 220, the user 108 configures the CPE gateway 106 for port forwarding to permit remote access to the M2M device 102. After completing the above manual provisioning procedure, the user 108 can employ a remote controlling host 122 with the aforementioned IP address and port number to access the now provisioned M2M device 102. Unfortunately, manually provisioning of M2M devices with WiFi interfaces (e.g., the M2M device 102) suffer from a number of deficiencies. Conventional manual procedures for connecting the WiFi-equipped IP M2M device 102 to the WAN 112 via the CPE gateway 106 require the user 108 to have expertise in configuring WiFi and IP networks. Conventional manual procedures often require trial-and-error even for users having knowledge of WiFi and IP networking. WiFi-equipped M2M devices of different models or made by different vendors have their own distinct or varying initial provisioning and configuration procedures. Incorrect manual provisioning may result in lengthy service interruptions of active devices when manually provisioning a new device in the same gateway area 104 (e.g., in an office, a factory, a service area, a multi-unit dwelling, a house, etc.). For a large number of WiFi-equipped M2M devices in the gateway area 104, manual initial provisioning takes time and effort even for professional installers. A manually provisioned M2M device 102 cannot be managed centrally by a communications or M2M service provider. When the M2M device 102 is reset to a factory default setting (e.g., after power failures), the user 108 needs to repeat the manual procedure to re-provisioning the M2M device 102. Manual initial provisioning or re-provisioning procedures may require the user 108 to be physically located behind the CPE gateway 106.

Accordingly, what would be desirable, but has not yet been provided, is an automated system and method for provisioning an M2M device having a WiFi interface.

### SUMMARY OF THE INVENTION

The above-described problems are addressed and a technical solution is achieved in the art by providing a method and system for automatically provisioning a machine-to-machine (M2M) device. A WiFi M2M gateway identifies a WiFi network identifier (ESSID) broadcast by a powered-on M2M device in WiFi ad hoc mode through a scanning procedure and joins the WiFi ad hoc network defined by the M2M device. The WiFi M2M gateway obtains (device) identification information (e.g., MAC address) received from the M2M device. The WiFi M2M gateway transmits a command to the M2M device to switch from ad hoc mode to infrastructure mode to connect with a WAN. The WiFi M2M gateway registers the M2M device with an M2M server associated with a service provider based on the device information of the M2M device. The WiFi M2M gateway receives a fully qualified domain name (FQDN) associated with the M2M device from the M2M server.

In one embodiment, the WiFi M2M gateway maintains at least one other connection in ad hoc mode after switching an M2M device from ad hoc mode to infrastructure mode when provisioning new M2M devices and servicing provisioned M2M devices concurrently in the same gateway area is required.

In one embodiment, obtaining device information is at least one of a name, an IP address, and a MAC address of the M2M device. The IP address may be in one of IPv4 format or IPv6 format. The name may be a user login name, a password, or both, which is used for M2M devices with a built-in Web server for remote access via a Web client. The device identification information may be stored in a processing queue and a database in a M2M gateway and a M2M server.

In one embodiment, registering the M2M device with an M2M server associated with a service provider based on the device information of the M2M device comprises creating a device management (DM) message with the device information of the M2M device as a payload and transmitting the DM message to the M2M server.

The above-described problems are addressed and a technical solution is achieved in the art by providing a method and system for automatically provisioning a machine-to-machine (M2M) device. An M2M server associated with a service provider receives (device) identification information of an M2M device from a WiFi M2M gateway. The M2M server transmits a message with the device information of the M2M device as a payload to a domain name server (DNS). The M2M server receives a fully qualified domain name (FDQN) associated with the M2M device from the DNS. The M2M server transmits the FDQN to the WiFi M2M gateway. To enable communication with a M2M device behind a CPE gateway with network address translation (NAT), a special DNS record for NAT tunneling (e.g., NAT3D) is provisioned in the DNS for obtaining the FQDN. A regular record in the DNS to map the FQDN is provisioned for a M2M device without network address translation (NAT).

In one embodiment, device information is stored in the GDD and the SDD at the service provider network is kept in sync with that in the GDD, which is used to facilitate a fast response for at least one of retrieving or updating device information in a gateway area.

In one embodiment, the M2M server determines whether there is at least one application associated with the M2M device and launches the at least one application when at least one application is found.

In one embodiment, the M2M server queries a database for an entry corresponding to the device identification information received corresponding to the M2M device. If no entry is found, the M2M server creates a new record in the database based on the device identification information.

### BRIEF DESCRIPTION OF THE DRAWINGS

The present invention may be more readily understood from the detailed description of an exemplary embodiment presented below considered in conjunction with the attached drawings and in which like reference numerals refer to similar elements and in which:

FIG. 1 illustrates a conventional hardware architecture for manually provisioning a WiFi-equipped M2M device over the Internet 112;

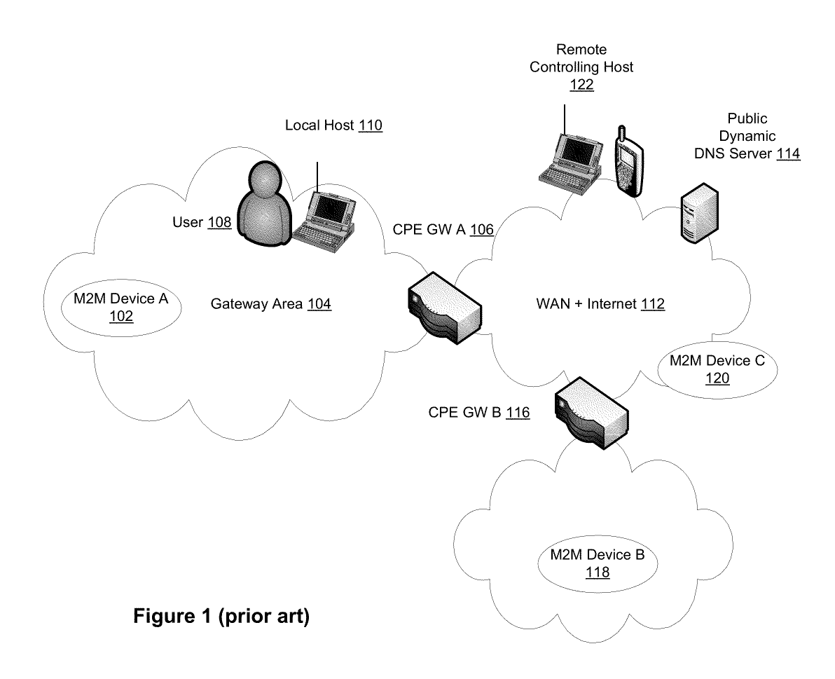

FIG. 2 is a process flow diagram illustrating a conventional manual method for provisioning an IP M2M device with a WiFi interface;

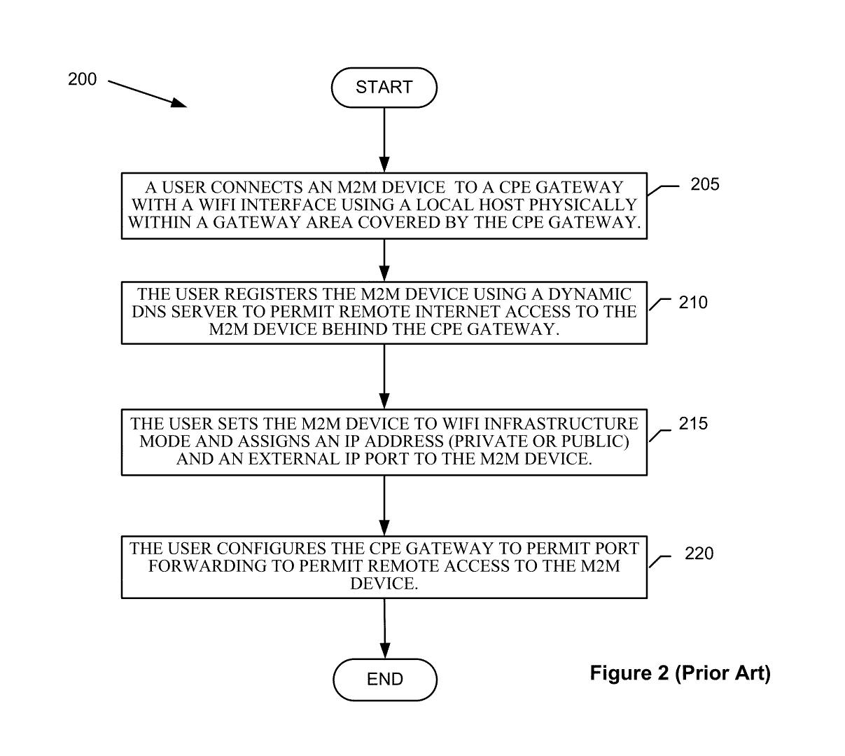

FIG. 3 illustrates an automatic provisioning environment for WiFi-equipped M2M devices in which embodiments of the present invention may operate;

FIG. 4 is a high-level block diagram and process flow illustrating one embodiment of a method for automating the provisioning of WiFi-equipped M2M devices over a wired or wireless network employing a WiFi M2M gateway;

FIG. 5 is a high-level process flow illustrating one embodiment of a method executed by a WiFi M2M gateway and an M2M server for automating the provisioning of WiFi-equipped M2M devices over a wired or wireless network from a point of view of the automatic provisioning environment of FIG. 3 during initialization of an M2M device;

FIG. 6 is a process flow illustrating one embodiment of a method for automating the provisioning of WiFi-equipped M2M devices from the viewpoint of a WiFi M2M gateway;

FIG. 7 is a process flow illustrating one embodiment of a method for automating the provisioning of a WiFi-equipped M2M device wherein an WiFi M2M gateway is configured to register the M2M device with an M2M server associated with a service provider;

FIG. 8 is a process flow illustrating one embodiment of a method for automating the provisioning of a WiFi-equipped M2M device from the viewpoint of the M2M server; and

FIG. 9 illustrates a diagrammatic representation of a machine applicable to a M2M server and a M2M gateway in the exemplary form of a computer system within which a set of instructions, for causing the machine to perform any one or more of the methodologies discussed herein, may be executed.

It is to be understood that the attached drawings are for purposes of illustrating the concepts of the invention and may not be to scale.

### DETAILED DESCRIPTION OF THE INVENTION

The present invention relates to a system and method for automating the provisioning of WiFi-equipped M2M devices with a WiFi M2M gateway in a gateway area in conjunction with an M2M Server and a DNS Server in a service provider network. Although described in terms of provisioning of M2M devices with only a WiFi IP interface, embodiments of the present invention may be extended to cover auto-provisioning of M2M devices with other communication interfaces.

As used herein, the term “program”, “application”, “software package” or “computer executable instructions” refers to instructions that may be performed by a processor and/or other suitable components. The term “computer” or “server”, as used herein, is not limited to any one particular type of hardware device, but may be any data processing device such as a desktop computer, a laptop computer, a kiosk terminal, a personal digital assistant (PDA) or any equivalents or combinations thereof. Any device or part of a device configured to process, manage or transmit data, whether implemented with electrical, magnetic, optical, biological components or otherwise, may be made suitable for implementing the invention described herein.

As used herein, the term communicatively connected is intended to include any type of connection, whether wired or wireless, in which data may be communicated. Furthermore, the term “communicatively connected” is intended to include a connection between devices and/or programs within a single computer or between devices and/or programs on separate computers.

Although specific embodiments have been illustrated and described herein, those of ordinary skill in the art will appreciate that an arrangement configured to achieve the same results may be substituted for the specific embodiments shown. This disclosure is intended to cover adaptations or variations of various embodiments of the present disclosure. It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the present disclosure includes other applications in which the above structures and methods are used.

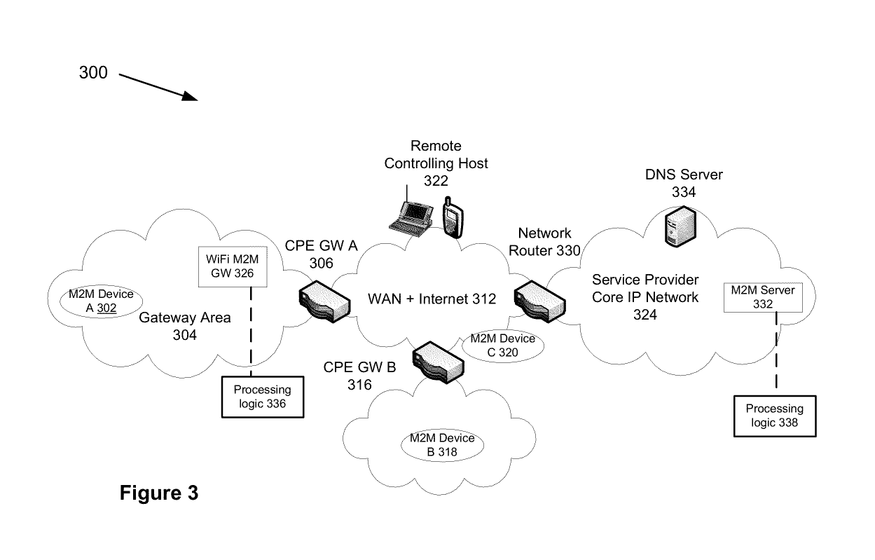

FIG. 3 illustrates an automatic provisioning environment 300 in which embodiments of the present invention may operate. The WiFi-equipped M2M device 302 (M2M Device A) is located within a coverage area (i.e., the gateway area 304) serviced by a CPE gateway 306. The M2M device 302 may be provided with access to a wide area network (WAN) communicatively coupled to the Internet 312 via a wireless router (WiFi access point) and a WAN gateway (e.g., a cable/DSL/fiber/WiMAX modem, a router, or a 3G/4G radio device) or a CPE gateway (e.g., a 3G/4G MiFi, or combined box with Fiber modem and wireless router), the latter combining the functions of wireless router and WAN gateway. As used herein, a CPE gateway (e.g., CPE Gateway A 306) denotes a node connected to the M2M device 302 with the WAN 112. The CPE gateway 306 additionally provides a network address translation (NAT) function for M2M devices that are accessed with a private IPv4 address.

The automatic provisioning environment 300 further includes a service provider core IP network 324 and a WiFi M2M gateway 326 located in the gateway area 304. The service provider core IP network 324 further comprises an IP-connected network router 330, an M2M server 332, and a DNS server 334 under the management of a service provider (not shown).

The WiFi M2M gateway 326 comprises a WiFi interface, a direct connection (i.e., wireline, e.g., as internal bus, e.g., USB) or a wireless connection (e.g., Bluetooth) communicatively connected to the CPE gateway 306. In one embodiment, the WiFi M2M gateway 326 and the M2M server 332 comprise processing logic 336 for automating the provisioning of the M2M device 302 over a wired or wireless wide area network (WAN) (e.g., the Internet) 312. The WiFi M2M gateway can be integrated with the CPE gateway in one physical box to ease installation, shipping, and save equipment costs and operating space.

The M2M server 332 comprises processing logic 338 configured to provide centralized device management functionality for M2M devices (e.g., M2M device 302) associated with the service provider's subscribers. The DNS server 334 is configured to manage device name-to-IP address mapping and provides a FDQN to be associated with the M2M device 302 in the service provider's administration domain. As a result, the M2M device 302 in a gateway area 304 becomes accessible to a remote controlling host 322 (e.g., a smart phone or a laptop) or to another M2M device 318 within another gateway area covered by a second CPE gateway 316 (e.g., M2M Device B 318) with a private address, or to another M2M device 320 (e.g., M2M Device C 120) having a public IP address.

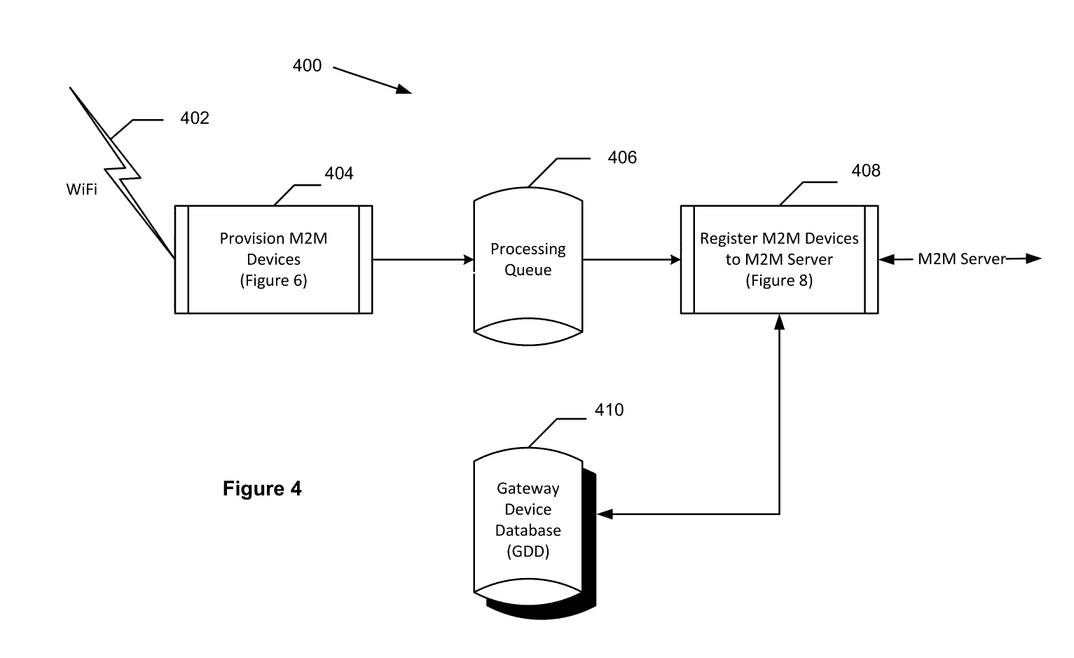

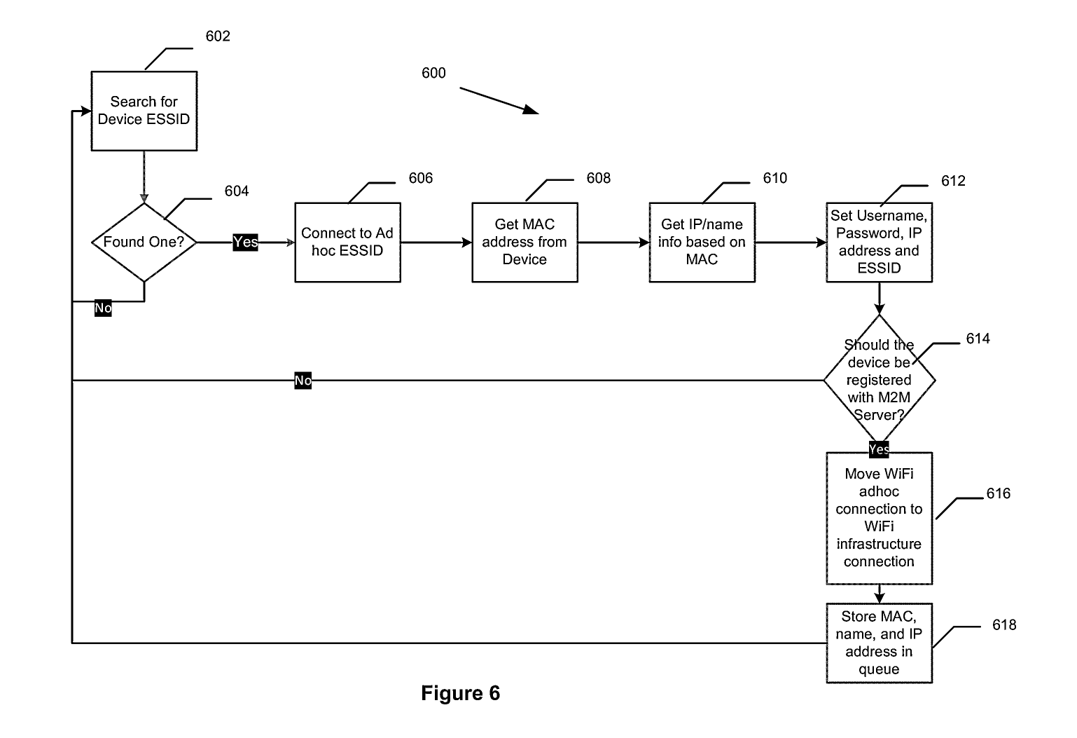

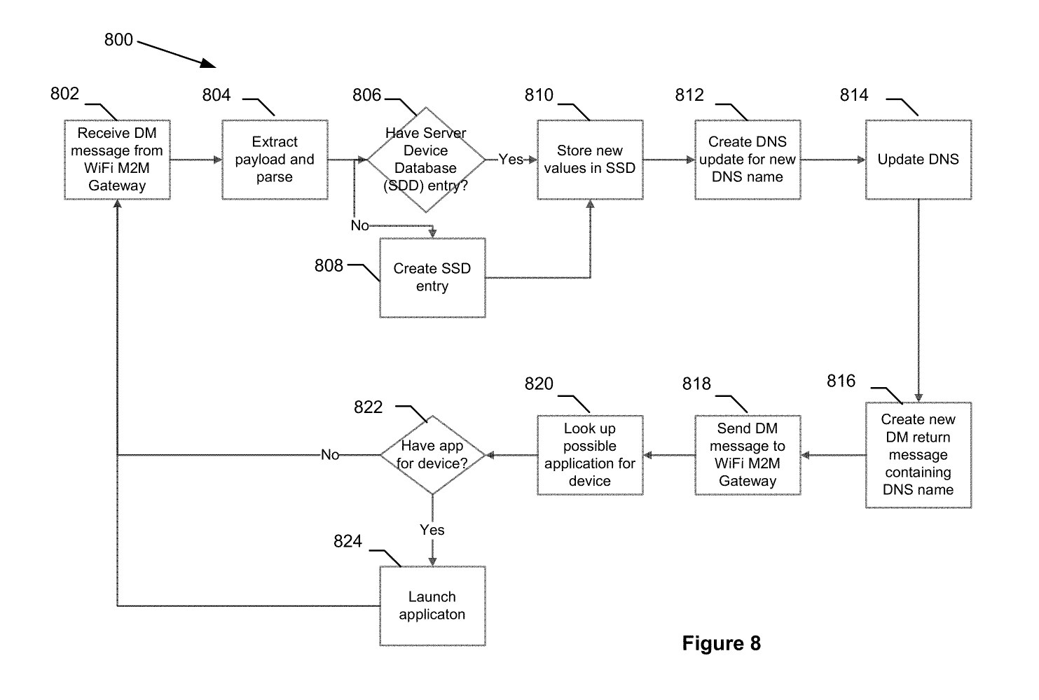

FIG. 4 is a high-level block diagram and process flow 400 illustrating one embodiment of a method for automating the provisioning of WiFi-equipped M2M devices over a wired or wireless network employing a WiFi M2M gateway. The WiFi M2M gateway 326 is configured to receive data over WiFi 402 from the M2M device 318. At block 404, the WiFi M2M gateway 326 provisions the M2M device 318 in WiFi ad hoc mode and switches the M2M device 318 to WiFi infrastructure mode to connect with a WAN (See FIG. 6). The WiFi M2M gateway 326 further schedules a provisioning request for the M2M device 318 by placing M2M device information in a processing queue 406. At block 408, the WiFi M2M gateway 326 registers the M2M device 318 with the service provider's M2M server 332 via the CPE gateway 306, the WAN 112, and the service provider core IP network 324 (See FIG. 8). Device identification information provided during registration of the M2M device 302 is updated in the Gateway Device Database (GDD) 410.

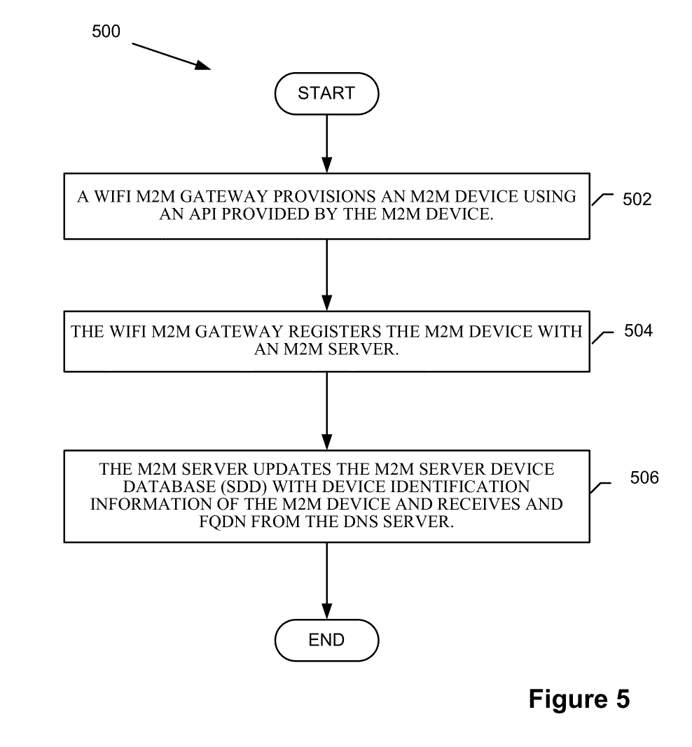

FIG. 5 is a high-level process flow illustrating one embodiment of a method 500 executed by a WiFi M2M gateway and an M2M server for automating the provisioning of WiFi-equipped M2M devices over a wired or wireless network from a point of view of the automatic provisioning environment 300 during initialization of the M2M device 302. At block 502, the WiFi M2M gateway 326 provisions the M2M device 302 using an API provided by the M2M device 302. At block 504, the WiFi M2M gateway 326 registers the M2M device 302 with the M2M Server 332. At block 506, the M2M server 332 updates an M2M Server Device Database (SDD) (not shown) with the device identification information of the M2M device 302 and receives and FQDN applied to the M2M device 302 from the DNS server 334.

In circumstances when the M2M device 302 device is rebooted to default factory setting (e.g., due to power failure), the automatic re-provisioning procedure of FIG. 5 is repeated. In one embodiment, an automatic re-provisioning procedure is the same as the automatic initial provisioning procedure, since all of the steps in the procedure are idempotent.

FIG. 6 is a process flow illustrating one embodiment of a method 600 for automating the provisioning of WiFi-equipped M2M devices 302 from the viewpoint of the WiFi M2M gateway 326. In one embodiment, both the M2M device 302 and the WiFi M2M gateway 326 are initially configured for WiFi operation in ad hoc mode. It is also assumed that both the M2M device 302 and the WiFi M2M gateway 326 may accept an IP address of the M2M device in IPv4 format, IPv6 format, or both.

At block 602, the WiFi M2M gateway 326 searches for an Extended Service Set Identification (ESSID)—a WiFi network identifier. If, at block 604, no ESSID is found, then processing returns to block 602. If at bock 604, an ESSID is found, then at block 606, the M2M gateway 326 performs an ad hoc connection to a device (e.g., the M2M devices 302) associated with the ESSID. At block 608, the M2M gateway 326 obtains a MAC address of the device (e.g., the M2M devices 302). At block 610, the M2M gateway 326 obtains a corresponding IP address and optional name of the M2M devices 302 based on the received MAC address of the M2M devices 302. At block 612, the M2M gateway 326 stores the received ESSID, IP address, and optional name in the Gateway Device Database (GDD) 410. Note that the optional steps of obtaining and setting end-user credentials (username, password) for authentication are only needed for M2M devices with a Web server 302. The User id/password can be pre-set via other process and stored in the GDD database.

If, at block 614, the M2M device 302 does not need to be registered with the M2M server 332 (e.g., for billing or accounting purposes), then processing returns to block 602, otherwise, at block 616, the M2M gateway 326 transmits a command to the M2M device 302 to switch from WiFi ad hoc mode to WiFi infrastructure mode. At block 618, the M2M gateway 326 stores the MAC address, optional name information, and IP address information of the M2M device 302 in the processing queue 406 of the M2M gateway 326 for transmission to the M2M server 332 over the Internet 312.

It should be noted that other active M2M devices already provisioned may be operating in infrastructure mode while the WiFi M2M gateway 326 is instructed to provision a new M2M device (i.e., block 602). To avoid service interruption for the active M2M device(s) already connected with the CPE gateway 326 while a new M2M device (e.g., M2M device 302) is being provisioned, it is important that both the WiFi M2M gateway 326 and the CPE gateway 306 each have their own WiFi radio and have separate direct links (e.g., internal bus, USB, Bluetooth) to connected M2M devices. This is to initiate a request and receive a response on an available IP address associated with the WiFi infrastructure connection when moving over from ad hoc to infrastructure mode of the M2M device 302, respectively.

In circumstances where a service interruption to active devices is acceptable while provisioning a new device in the same gateway area (e.g., provisioning a small number of devices in a hotel), the processing logic 336 of the WiFi M2M gateway 326 may be integrated with CPE gateway 306 for M2M device provisioning. One example of an integrated box is a smart phone with MiFi (as a portable CPE gateway) with the processing logic 336 running as a mobile application.

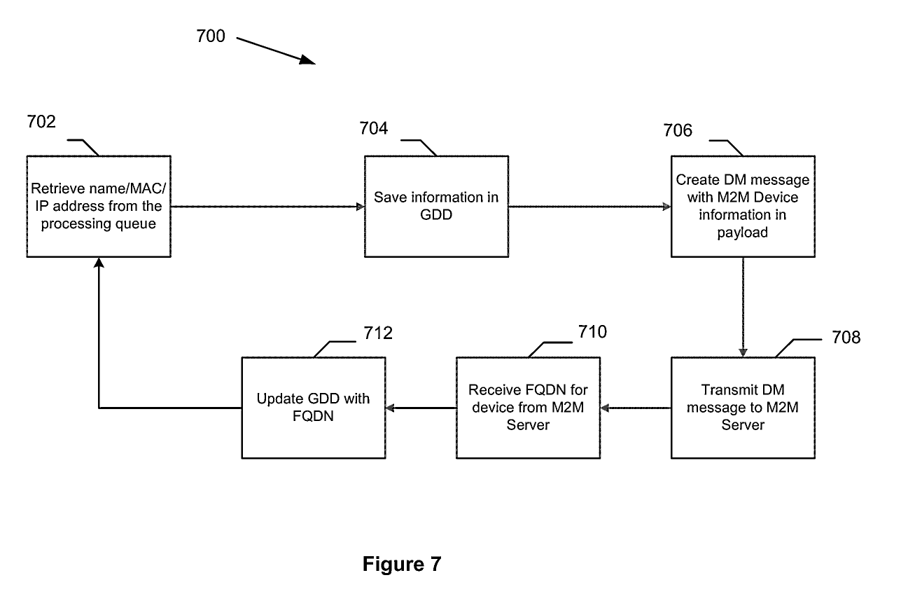

FIG. 7 is a process flow illustrating one embodiment of a method 700 for automating the provisioning of the WiFi-equpped M2M device 302 wherein the WiFi M2M gateway 326 is configured to register the M2M device 302 with an M2M server 332 associated with the service provider. At block 702, the WiFi M2M gateway 326 retrieves device identification information (e.g., the name, the MAC address, and the IP address) associated with the M2M device 302 from the processing queue 406 of the WiFi M2M gateway 326. At block 704, the WiFi M2M gateway 326 stores or updates the identification information associated the M2M device 302 in the gateway device database (GDD) 410. At block 706, the WiFi M2M gateway 326 creates a device management (DM) message with the device identification information placed in the payload of the DM message. At block 708, the WiFi M2M gateway 326 transmits the DM message to the M2M server 332. At block 710, the WiFi M2M gateway 326 receives an FDQN assigned to the M2M device 302 from the M2M server 332. At block 712, the WiFi M2M gateway 326 updates a record associated with the M2M device 302 in the gateway device database (GDD) 410 with the assigned FDQN. Blocks 702-712 are repeated if another record of device information (for the same or other M2M device 302) is present in the processing queue 406.

FIG. 8 is a process flow illustrating one embodiment of a method 800 for automating the provisioning of the WiFi-equipped M2M device 302 from the viewpoint of the M2M server 332. At block 802, the M2M server 332 receives a DM message from the WiFi M2M gateway 326. At block 804, the payload of the DM message is extracted and parsed by the M2M server 332. At block 806, the M2M server 332 queries the server device database (SDD) for an entry corresponding to the device identification information received corresponding to the M2M device 302. If, at block 806, there is no entry corresponding device identification information associated with the M2M device 302, then at block 808, a new entry is created in the SDD. At block 810, the device identification information in the parsed payload is stored as a new record in the SSD. At block 812, the M2M server 332 creates a DNS update request message for a new DNS domain name (i.e., the FQDN) to be assigned to the M2M device 302. At block 814, the M2M server 332 transmits the DNS update request message to the DNS 334. The M2M server 332 receives a new FDQN from the DNS 334. At block 816, the M2M server 332 incorporates the FDQN into a payload of a reply DM message. At block 818, the M2M server 332 transmits the reply DM message to the WiFi M2M gateway 326. Optionally, at block 820, the M2M server 332 determines whether there are one or more applications associated with the M2M device 302. If, at block 822, an application is found, then at block 824, the application is launched. Processing then returns to block 802 for the next received DM message.

Embodiments of the present invention have several advantages over prior art M2M device provisioning methods. By employing the WiFi M2M gateway 306 in the gateway area 304 and the M2M server 332 and the DNS server 334 in the service provider IP core network 324, embodiments of the present invention may provide for automatic initial provisioning and re-provisioning of M2M devices. The WiFi M2M gateway 306 and the M2M server 332 further provide for automatic M2M device registration for centralized device management by a service provider and enable device access by other devices in a public or a private IP network via a service provider supplied FQDN. The WiFi M2M gateway 306 and the M2M server 332 are configured to permit automatic provisioning of the M2M device 302 remotely (outside of the gateway area). The WiFi M2M gateway 306 and the M2M server 332 provide support for M2M devices with IPv6 addresses and/or IPv4 addresses. The WiFi M2M gateway 306 can provide automatic provisioning of multiple M2M devices without service interruption of active devices in the same gateway area.

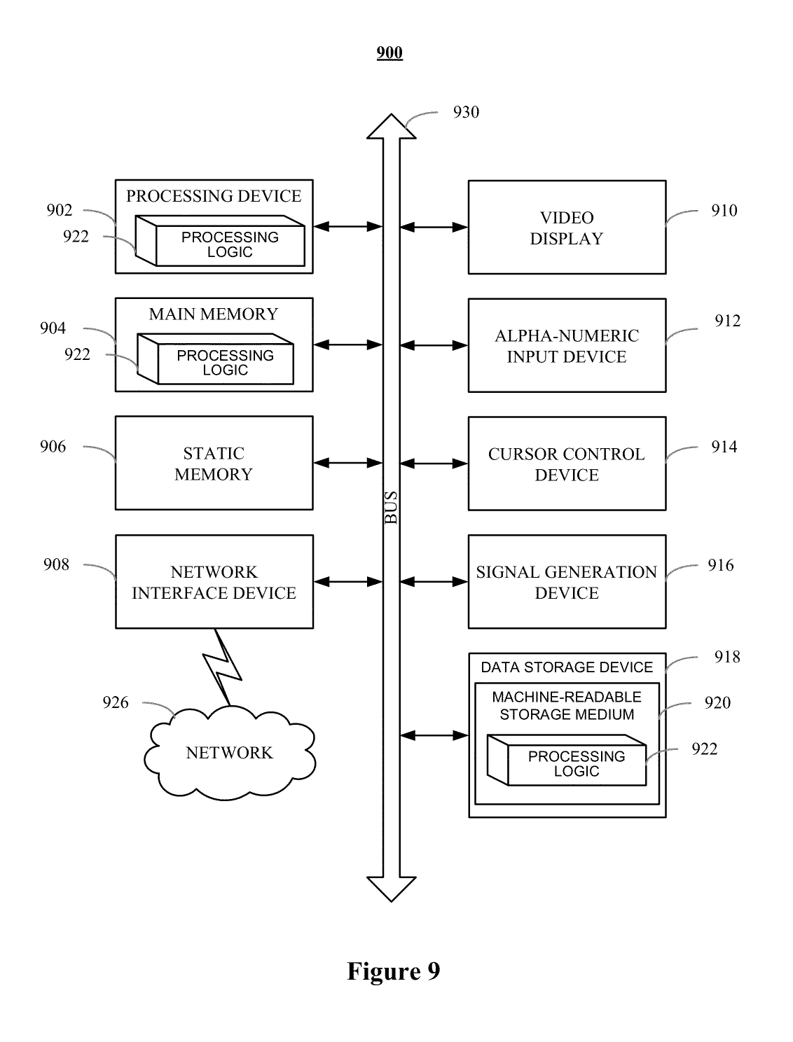

FIG. 9 illustrates a diagrammatic representation of a machine in the exemplary form of a computer system 900 applicable to a M2M server and a M2M gateway (which may have limited human interfaces 910-916) within which a set of instructions, for causing the machine to perform any one or more of the methodologies discussed herein, may be executed. In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a personal digital assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 900 includes a processing device 902, a main memory 904 (e.g., read-only memory (ROM), flash memory, dynamic random access memory (DRAM) (such as synchronous DRAM (SDRAM) or Rambus DRAM (RDRAM), etc.), a static memory 906 (e.g., flash memory, static random access memory (SRAM), etc.), and a data storage device 918, which communicate with each other via a bus 930.

Processing device 902 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 902 may also be one or more special-purpose processing devices such as an application specific integrated circuit (ASIC), a field programmable gate array (FPGA), a digital signal processor (DSP), network processor, or the like. Processing device 902 is configured to the processing logic 922 for performing the operations and steps discussed herein.

Computer system 900 may further include a network interface device 908. Computer system 900 also may include a video display unit 910 (e.g., a liquid crystal display (LCD) or a cathode ray tube (CRT)), an alphanumeric input device 912 (e.g., a keyboard), a cursor control device 914 (e.g., a mouse), and a signal generation device 916 (e.g., a speaker).

Data storage device 918 may include a machine-readable storage medium (or more specifically a non-transitory computer-readable storage medium) 1020 having one or more sets of instructions (e.g., the processing logic 336, 332 of FIG. 3) embodying any one or more of the methodologies of functions described herein. The processing logic 336, 332 may also reside, completely or at least partially, within main memory 904 and/or within processing device 902 during execution thereof by computer system 900; main memory 904 and processing device 902 also constituting machine-readable storage media. Content processing logic 922 may further be transmitted or received over a network 926 via network interface device 908.

Machine-readable storage medium 920 may also be used to store the device queue manager logic persistently. While machine-readable storage medium 920 is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instruction for execution by the machine and that causes the machine to perform any one or more of the methodologies of the present invention. The term “machine-readable storage medium” shall accordingly be taken to include, but not be limited to, solid-state memories, and optical and magnetic media.

The components and other features described herein may be implemented as discrete hardware components or integrated in the functionality of hardware components such as ASICs, FPGAs, DSPs or similar devices. In addition, these components may be implemented as firmware or functional circuitry within hardware devices. Further, these components may be implemented in any combination of hardware devices and software components.

Some portions of the detailed descriptions are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the above discussion, it is appreciated that throughout the description, discussions utilizing terms such as “enabling”, “transmitting”, “requesting”, “identifying”, “querying”, “retrieving”, “forwarding”, “determining”, “passing”, “processing”, “disabling”, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the present invention also relate to an apparatus for performing the operations herein. This apparatus may be specially constructed for the required purposes or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs and magnetic-optical disks, read-only memories (ROMs), random access memories (RAMs), EPROMs, EEPROMs, magnetic or optical cards, flash memory devices including universal serial bus (USB) storage devices (e.g., USB key devices) or any type of media suitable for storing electronic instructions, each of which may be coupled to a computer system bus.

The algorithms and displays presented herein are not inherently related to any particular computer or other apparatus. Various general purpose systems may be used with programs in accordance with the teachings herein or it may prove convenient to construct more specialized apparatus to perform the required method steps. The required structure for a variety of these systems will be apparent from the description above. In addition, the present invention is not described with reference to any particular programming language. It will be appreciated that a variety of programming languages may be used to implement the teachings of the invention as described herein.

It is to be understood that the above description is intended to be illustrative, and not restrictive. Many other embodiments will be apparent to those of skill in the art upon reading and understanding the above description. Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense. The scope of the invention should, therefore, be determined with reference to the appended claims, along with the full scope of equivalents to which such claims are entitled.

What is claimed is:

1. A computer-implemented method for automatically provisioning a machine-to-machine (M2M) device, comprising the steps of:
identifying, by a scanning procedure of a WiFi M2M gateway, a WiFi network identifier being broadcast by a M2M device initially set in an ad hoc mode;
joining a WiFi ad hoc network set by the M2M device;
obtaining device information from the M2M device over a WiFi connection;
transmitting a command to the M2M device to switch from the ad hoc mode to an infrastructure mode;
storing the device information of the M2M device in a gateway device database (GDD);
registering the M2M device with an M2M server associated with a service provider based on the device information; and
receiving a fully qualified domain name (FQDN) associated with the M2M device from the M2M server.

2. The method of claim 1, wherein the WiFi M2M gateway maintains at least one other connection in ad hoc mode after switching the M2M device from ad hoc mode to infrastructure mode when provisioning new M2M devices and servicing provisioned M2M devices concurrently in the same gateway area is required.

3. The method of claim 1, wherein the obtaining device information is at least one of a name, an IP address, and a MAC address of the M2M device.

4. The method of claim 3, wherein the name is employed when the M2M device includes a Web server to enable remote access to the M2M device via a Web client.

5. The method of claim 3, wherein the name is a user login name, a password, or both.

6. The method of claim 3, wherein the IP address is in one of IPv4 format or IPv6 format.

7. The method of claim 1, wherein registering the M2M device with an M2M server associated with a service provider based on the device information of the M2M device comprises creating a Device Management (DM) message with the device information of the M2M device as a payload and transmitting the DM message to the M2M server.

8. The method of claim 1, wherein the device information is stored in the GDD during provisioning time to facilitate a fast response for at least one of retrieving or updating device information in a gateway area.

9. A computer-implemented method for automatically provisioning a machine-to-machine (M2M) device, comprising the steps of:
receiving, by a M2M server associated with a service provider, device information of an M2M device from a WiFi M2M gateway;
registering the device information in a server device database (SDD);
transmitting a message with the device information of the M2M device as a payload to a domain name server (DNS);
receiving a fully qualified domain name (FDQN) associated with the M2M device from the DNS; and
transmitting the FDQN to the WiFi M2M gateway.

10. The method of claim 9, further comprising provisioning a special DNS record for NAT tunneling in the DNS for obtaining the FQDN to enable communication with a M2M device behind a CPE gateway with network address translation (NAT).

11. The method of claim 9, further comprising provisioning a regular record in the DNS to map the FQDN for a M2M device without network address translation (NAT).

12. The method of claim 9, wherein the device information stored in the SDD at the service provider network during provisioning time is kept in sync with that in the GDD, which is used to facilitate a fast response for at least one of retrieving or updating device information in a gateway area.

13. A computer system, comprising:
a memory;
a processing device, coupled to the memory; and
an operating system hosted by the computer system, having access to the memory and use of the processor, the operating system configured to:
identify, by a scanning procedure, a WiFi network identifier being broadcast by a M2M device initially set in an ad hoc mode;
join a WiFi ad hoc network set by the M2M device;
obtain device information from the M2M device over a WiFi connection;
transmit a command to the M2M device to switch from the ad hoc mode to an infrastructure mode;
store the device information of the M2M device in a gateway device database (GDD);
register the M2M device with an M2M server associated with a service provider based on the device information; and
receive a fully qualified domain name (FQDN) associated with the M2M device from the M2M server.

14. The system of claim 13, wherein the operating system maintains at least one other connection in ad hoc mode after switching the M2M device from ad hoc mode to infrastructure mode when provisioning new M2M devices and servicing provisioned M2M devices concurrently in the same gateway area is required.

15. The system of claim 13, wherein the device information is stored in the GDD during provisioning time to facilitate a fast response for at least one of retrieving or updating device information in a gateway area.

16. A computer system, comprising:
a memory;
a processing device, coupled to the memory; and
an operating system hosted by the computer system, having access to the memory and use of the processor, the operating system configured to:
receive device information of an M2M device from a WiFi M2M gateway;
register the device information in a server device database (SDD);
transmit a message with the device information as a payload to a domain name server (DNS);
receive a fully qualified domain name (FDQN) associated with the M2M device from the DNS; and
transmit the FDQN to the WiFi M2M gateway.

17. The system of claim 16, further comprising provisioning a special DNS record for NAT tunneling in the DNS for obtaining the FQDN to enable communication with a M2M device behind a CPE gateway with network address translation (NAT).

18. The system of claim 16, further comprising provisioning a regular record in the DNS to map the FQDN for a M2M device without network address translation (NAT).

19. The system of claim 16, wherein the device information stored in the SDD during provisioning time is kept sync with that in the GDD, which is used to facilitate a fast response for at least one of retrieving or updating device information in a gateway area.
